(19) United States
(12) Patent Application Publication
(10) Pub. No.: US 2005/0270778 A1
(43) Pub. Date: Dec. 8, 2005

(54) Loader light mounting apparatus

(75) Inventors: Gaylen Eugene Hicok, Charles City, IA (US); Robert James Recker, Waterloo, IA (US)

Correspondence Address: DEERE & COMPANY, ONE JOHN DEERE PLACE, MOLINE, IL, 61265, US

(73) Assignee: Deere & Company, a Delaware corporation

(21) Appl. No.: 10/862,755

(22) Filed: Jun. 7, 2004

(51) Int. Cl. F21V 33/00

(52) U.S. Cl. 362/253; 362/485

(57) ABSTRACT

A loader light assembly is provided for a tractor-mounted loader having a boom pivotally mounted on the tractor and a bucket pivotally mounted on an end of the boom. The light assembly includes a base fixed to a portion of the boom, an electric light unit, and a rotational coupling, such as a viscous fan drive unit, coupled between the base and the light unit. The light unit moves with the boom and rotates with respect to the boom so that the beam projected by the light unit is directed always in substantially the same direction regardless of boom position despite pivoting movement of the boom. The base includes a magnet which releasably clamps the base to a side surface of the boom.

### BACKGROUND

The present invention relates to a loader light or lamp assembly for mounting on a boom of a loader, such as a loader mounted on an agricultural tractor.

When a tractor-mounted loader, such as a front-end loader, is operated in a dark environment, it is difficult to illuminate the loader bucket adequately as the loader boom is raised and lowered. The standard tractor headlights cannot illuminate the bucket when the boom is raised. Lights fixed to the loader boom and oriented to illuminate the bucket and working area when the boom is lowered would be directed too far away from the working area when the boom is raised.

A Komatsu Wheel Loader WA800-3 includes lights on the ends of stalks which are mounted on and which project upwardly from a frame of the wheel loader. But, these lights have a fixed position and a fixed orientation, and are thus unable to provide desired illumination in all orientations of the loader boom.

### SUMMARY

Accordingly, an object of this invention is to provide a lighting apparatus which provides at least some illumination to a work area and to a loader bucket during different orientations of the loader boom.

A further object of the invention is to provide such a lighting apparatus which moves with the loader boom while maintaining a substantially constant light beam direction.

These and other objects are achieved by the present invention, wherein loader light apparatus is provided for a tractor-mounted loader having a boom pivotally mounted on the tractor and a bucket pivotally mounted on an end of the boom. The light apparatus includes a base fixed with respect to a portion of the boom, an electric light which projects an illuminating light beam, and a rotational coupling. The rotational coupling has a first part and a second part rotatable with respect to the first part. The first part is rigidly attached to the base, and the second part is attached to the light so that the light moves with the boom and so that the light beam is directed always in substantially the same direction regardless of boom position. The rotational coupling is preferably a fluid torque transmitter which allows gravitational force to maintain a substantially constant light beam direction, despite pivoting movement of the boom. The coupling also dampens swinging motions or vibrations of the light.

### BRIEF DESCRIPTION OF THE DRAWINGS

FIG. 1 is a side view of a tractor-mounted loader with a lighting apparatus according to the present invention;

FIG. 2 is an enlarged perspective view of the lighting apparatus of FIG. 1;

FIG. 3 is front view of the lighting apparatus according to the present invention; and

FIG. 4 is a side view of a portion of FIG. 1 with the loader arms in a raised position.

### DETAILED DESCRIPTION

Referring to FIG. 1, a conventional tractor-mounted loader 10 is mounted on a tractor 12. Although only the left side of the tractor/loader is shown in FIG. 1, the loader 10 includes left and right masts 14 mounted on the frame of the tractor 12, left and right booms 16 pivotally coupled to the masts 14, and a bucket 18 pivotally coupled to an ends of the booms 16. The booms 16 are raised and lowered by boom cylinders 20 and the bucket 18 is pivoted by bucket cylinders 22. According to the present invention, a light apparatus 30 is mounted on an outer side surface of both booms 16.

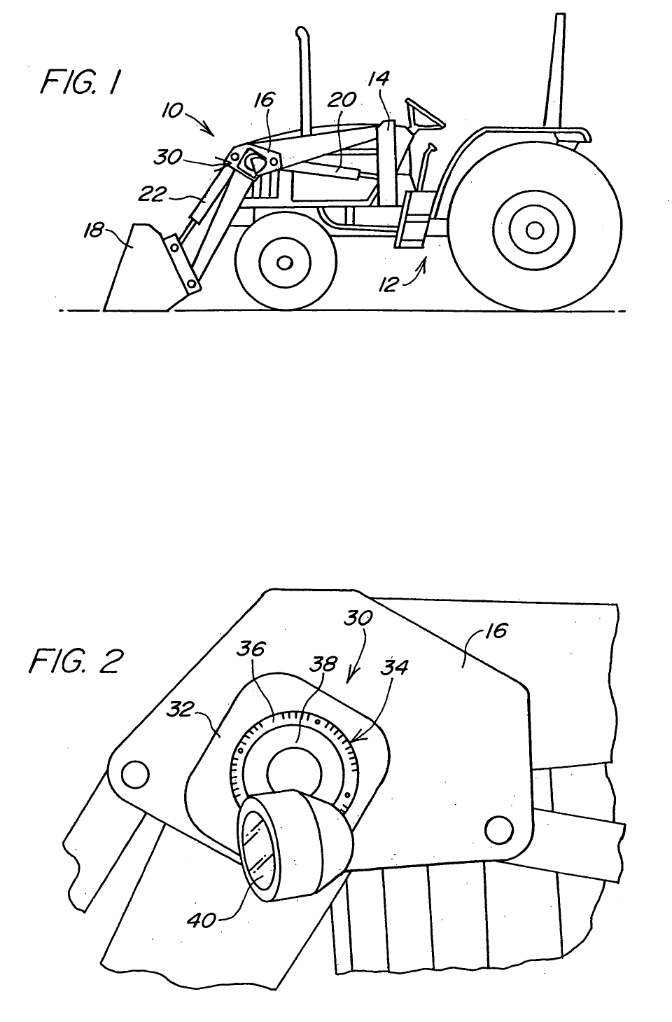

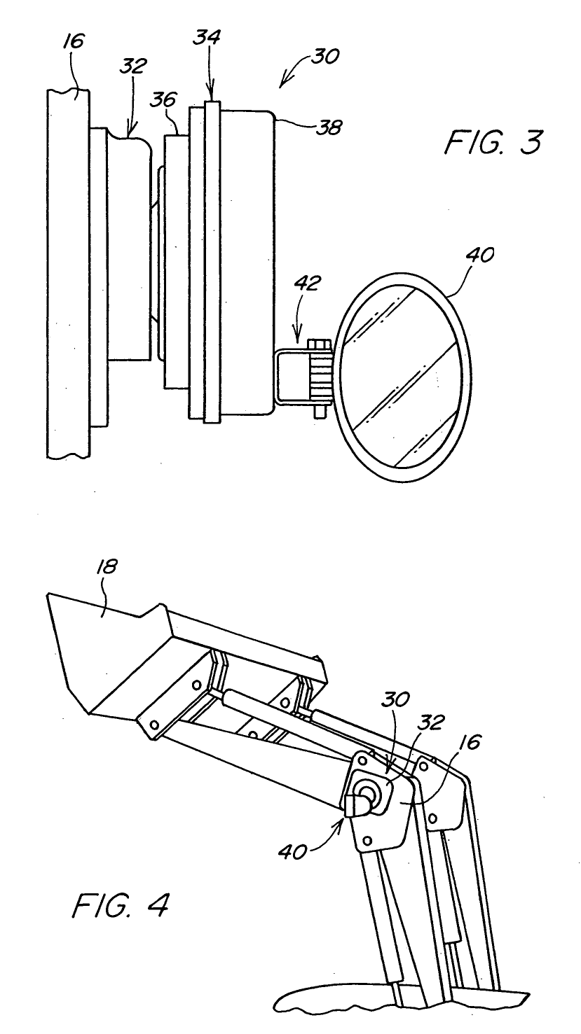

Referring now to FIGS. 2 and 3, the light apparatus 30 includes a base 32 attached to the side of the boom 16. A rotatable coupler 34 is attached to the base 32. The coupler includes a first part 36 attached to the base 32 and a second part 38 which is rotatable with respect to first part 36. An electric light, such as a spotlight 40 is attached by an adjustable bracket 42 to the second part at a location spaced away from the center of second part 38 and near an outer edge of part 38. The coupler 34 is preferably a commercially available fluid torque transmitter which allows damped rotation between two parts and which allows gravitational force to operate on the light 40 to maintain the direction of the beam substantially constant despite pivoting movement of the boom 16. The base 32 is preferably a commercially available magnetic mounting base. The coupler 34 is preferably a commercially available viscous fan drive unit.

As best seen in FIGS. 1 and 2, the loader boom 16 is in its lowered position, and the spotlight 40 is directed or aimed in a substantially forward and horizontal direction. Referring now to FIG. 4, the loader boom 16 is in a raised position, and the light apparatus 30 is still directed in a substantially forward and horizontal direction. Thus, the coupler 34 allows gravitational force to maintain spotlight 40 aimed substantially horizontally forward despite pivoting movement of the boom 16.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

1. A loader light assembly for a tractor-mounted loader having a boom pivotally mounted on the tractor and a bucket pivotally mounted on an end of the boom, the light assembly comprising:
an electric light unit for projecting an illuminating light beam; and
a rotational coupler having a first part and a second part rotatable with respect to the first part, the first part being attached to the boom, and the second part being attached to the light unit so that the light unit moves with the boom and rotates with respect to the boom so that the light beam is directed always in substantially the same direction regardless of boom position.

2. The loader light assembly of claim 1, wherein:
gravitational force operates on the light unit to maintain the direction of the beam substantially constant despite pivoting movement of the boom.

3. The loader light assembly claim 1, wherein:
the rotational coupler comprises a fluid torque transmitter.

4. The loader light assembly claim 3, wherein:
the rotational coupler dampens swinging motions of the lamp.

5. The loader light assembly claim 1, wherein:
the rotational coupler comprises viscous fan drive unit.

6. The loader light assembly claim 5, wherein:
the rotational coupler dampens swinging motions of the lamp.

7. The loader light assembly claim 1, wherein:
the first coupler part is attached to a base, the base including a magnet which releasably clamps the base to a side surface of the boom.

8. A loader light assembly for a tractor-mounted loader having a boom pivotally mounted on the tractor and a bucket pivotally mounted on an end of the boom, the light assembly comprising:
a base fixed with respect a portion of the boom;
an electric light for projecting an illuminating light beam; and
a rotational coupling having a first part and a second part rotatable with respect to the first part, the first part being attached to the base, and the second part being attached to the light so that the light moves the boom and so that the beam is directed always in substantially the same direction regardless of boom position.

9. The loader light assembly of claim 8, wherein:
gravitational force operates on the light to maintain the direction of the beam substantially constant despite pivoting movement of the boom.

10. The loader light assembly claim 9, wherein:
the rotational coupling comprises a fluid torque transmitter.

11. The loader light assembly claim 10, wherein:
the rotational coupling dampens swinging motions of the lamp.

12. The loader light assembly claim 8, wherein:
the base including a magnet which releasably clamps the base to a side surface of the boom.
